(19) United States
(12) Patent Application Publication
(10) Pub. No.: US 2012/0042257 A1
(43) Pub. Date: Feb. 16, 2012

(54) UPDATING APPLICATION DATA AFTER ANTICIPATING IMMINENT USE

(75) Inventors: Omar Aftab, Kirkland, WA (US); Syed Mansoor Jafry, Kirkland, WA (US)

(73) Assignee: MICROSOFT CORPORATION, Redmond, WA (US)

(21) Appl. No.: 12/854,580

(22) Filed: Aug. 11, 2010

(51) Int. Cl. G06F 15/16; G06F 3/01

(52) U.S. Cl. 715/738; 709/219

(57) ABSTRACT

Obtaining application data for applications executing on a computing device in anticipation of imminent use of the computing device. The computing device detects an occurrence of a pre-defined event on the first computing device and obtains the application data in response thereto. The application data updates applications executing on the computing device such as mail, calendar, contacts, etc. The pre-defined event includes a defined movement of the computing device (e.g., pulling the device out of pocket), the user unlocking the screen, etc. The application data may be obtained and provided to the user in several iterations in some embodiments to enhance the user experience. By waiting to obtain the application data until there is a likelihood of a possible demand for the data, the frequency of updates is reduced thus extending battery life of the computing device.

### BACKGROUND

Existing mobile devices execute applications such as mail applications, contacts applications, calendar applications, and the like. These applications rely on data provided by one or more web services. The applications maintain the latest data on the mobile devices by requesting updated data, receiving pushed data, or otherwise synchronizing with the web services. Each synchronization activity by one of the mobile devices, however, causes the radio on the mobile device to energize which consumes a significant amount of battery power. As more applications continue to execute on each of the mobile devices, the radio energizes more often and stays energized longer. The battery life on the mobile devices is reduced resulting in a degraded user experience.

Some existing systems reduce the frequency of synchronizations by scheduling each of the synchronizations at fixed intervals (e.g., every 15 minutes) or by synchronizing only upon an explicit request from the user. With these existing systems, however, the data used by the applications may not be up-to-date at any given time, thus presenting the user with possibly outdated and incorrect data. Further, the computing device may repeatedly check for new updates even when new data is not available thus consuming battery power without benefit to the user.

Other existing systems maintain an always-up-to-date status by receiving pushed data from another device as soon as the data becomes available. For mobile computing devices, however, battery consumption increases as the radio energizes each time new data is pushed.

### SUMMARY

Embodiments of the disclosure update application data on a computing device in response to a determination of imminent use of the computing device. A first computing device detects occurrence of a pre-defined event on the first computing device. Responsive to the detection, the first computing device obtains first application data from a second computing device. The first application data relates to applications executing on the first computing device. The obtained first application data is provided for display on the first computing device. The user interacts with the displayed first application data. The first computing device obtains second application data from the second computing device. The first application data includes metadata describing the second application data. The obtained second application data is provided for display on the first computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a mobile computing device obtaining application data from a server computing device.

FIG. 2 is an exemplary block diagram illustrating a first computing device obtaining application data from a second computing device.

FIG. 3 is an exemplary flow chart illustrating operation of a computing device to obtain first application data and second application data in response to detecting occurrence of a pre-defined event.

FIG. 4 is an exemplary flow chart illustrating just-in-time synchronization of application data between a first computing device and a second computing device.

FIG. 5A is an exemplary mobile computing device illustrating data items displayed in a user interface.

FIG. 5B is the exemplary mobile computing device from FIG. 5B illustrating additional detail for the data items displayed in the user interface.

Corresponding reference characters indicate corresponding parts throughout the drawings.

### DETAILED DESCRIPTION

Referring to the figures, embodiments of the disclosure enable anticipation of possible demand for application data 120 on a computing device. The anticipation is represented as detection of a pre-defined event 122 that prompts the computing device to obtain the application data 120. The application data 120 is used to update applications executing on the computing device. Aspects of the disclosure reduce latency in obtaining and providing the application data 120 yet also reduce battery power consumption by eliminating wasteful polling.

In some embodiments, the application data 120 is only downloaded responsive to detection of the pre-defined event 122 (or after a long idle time). In such embodiments, network traffic on the computing device is reduced and battery life is preserved. Aspects of the disclosure provide the perception of being always-up-to-date while reducing power consumption. The disclosure strategically scales down the frequency of data updates (e.g., synchronization) by eliminating updates at times when the update will not positively impact the user experience (e.g., user 108 is not interacting with the computing device, or the user 108 will not immediately consume the data). In embodiments in which the computing device is a mobile computing device 102, battery consumption is reduced by receiving multiple data items in a single transmission instead of over multiple transmissions.

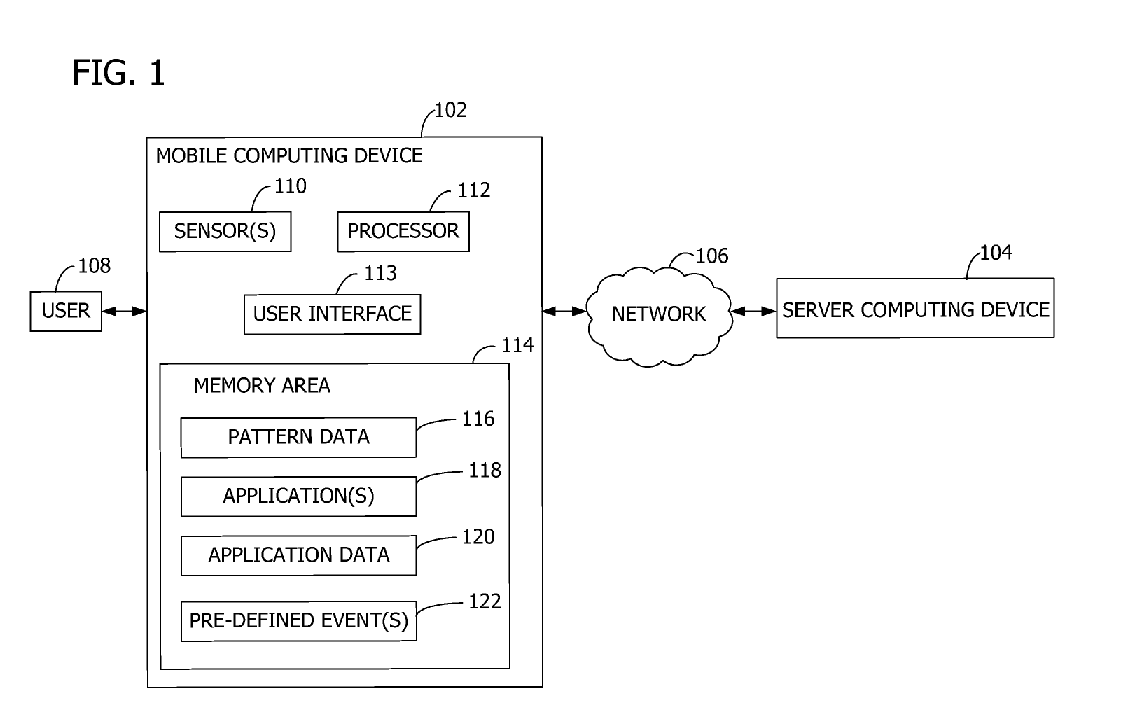

Referring again to FIG. 1, an exemplary block diagram illustrates the mobile computing device 102 obtaining application data 120 from a server computing device 104. The mobile computing device 102 includes, for example, any portable device executing instructions (e.g., application programs) to determine imminent use of the mobile computing device 102 and update application data 120 on the mobile computing device 102 in response thereto. In some embodiments, the mobile computing device 102 includes a mobile telephone, laptop, netbook, gaming device, and/or portable media player. Additionally, the mobile computing device 102 may represent a group of processing units or other computing devices.

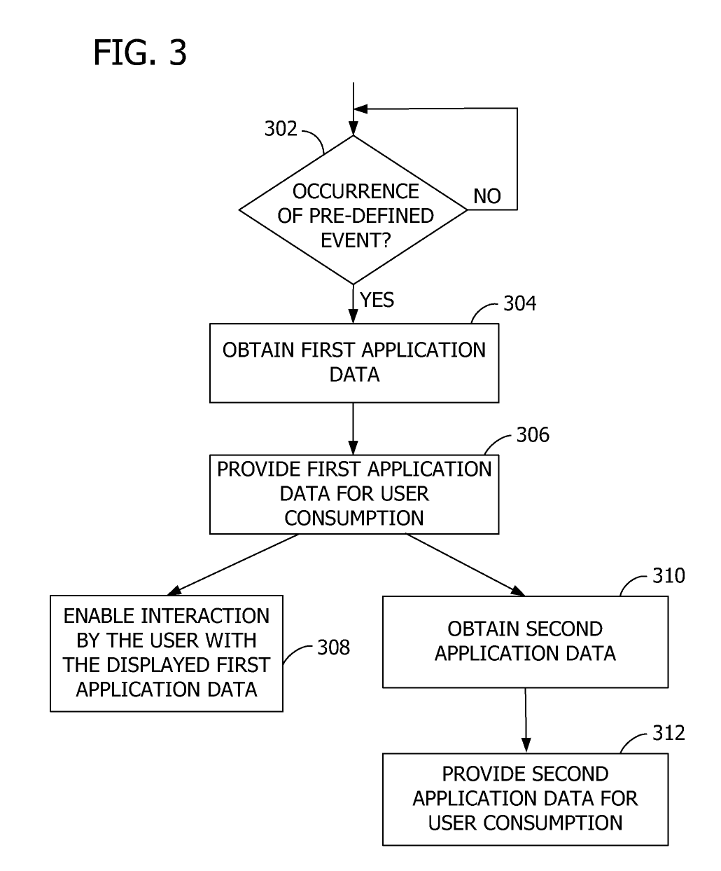

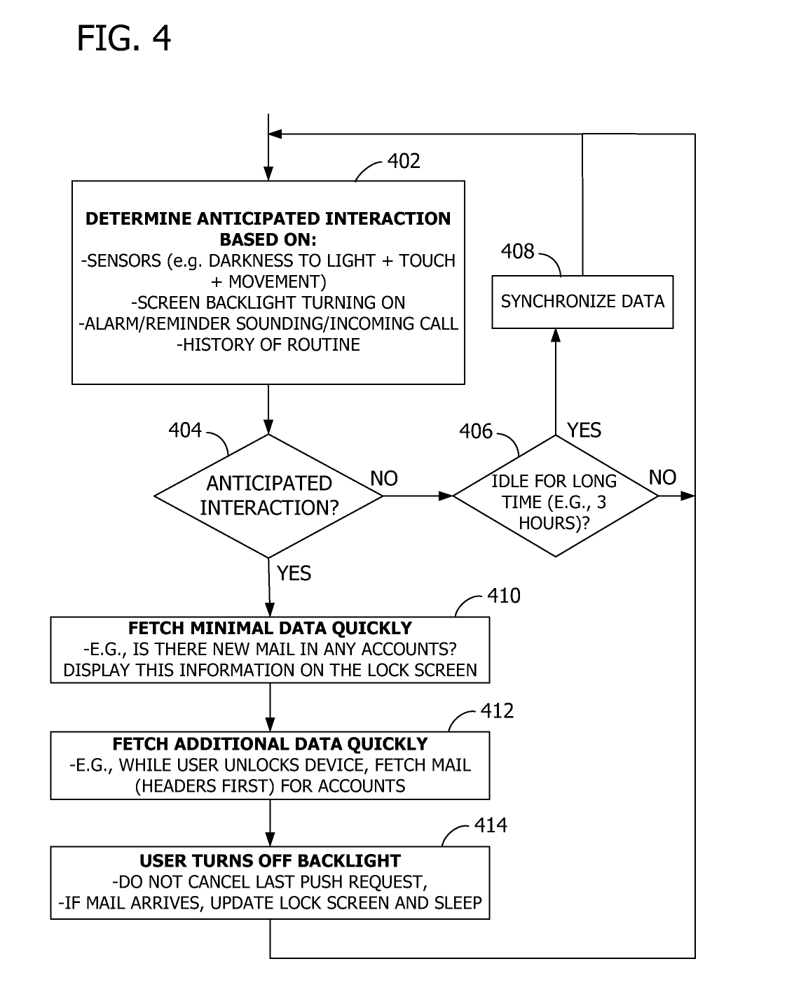

The mobile computing device 102 has at least one processor 112, at least one user interface 113, and one or more sensors 110. The processor 112 includes any quantity of processing units, and is programmed to execute computer-executable instructions for implementing aspects of the disclosure. The instructions may be performed by the processor 112 or by multiple processors executing within the computing device, or performed by a processor external to the mobile computing device 102. In some embodiments, the processor 112 is programmed to execute instructions such as those illustrated in the figures (e.g., FIG. 3 and FIG. 4).

The user interface 113 includes any interface for communicating with the user 108 of the mobile computing device 102. For example, the user interface 113 may provide content to the user 108 visually (e.g., via a screen such as a touch screen), audibly (e.g., via a speaker), and/or via touch (e.g., vibrations or other movement from the mobile computing device 102). In another example, the user interface 113 may receive from the user 108 tactile input (e.g., via buttons, an alphanumeric keypad, or a screen such as a touch screen) and/or audio input (e.g., via a microphone). In further embodiments, the mobile computing device 102 itself acts as the user interface 113 as the user 108 moves the mobile computing device 102 in a particular way to input commands.

In some embodiments, the sensors 110 include any element or feature of the mobile computing device 102 that receives stimuli external and/or internal to the mobile computing device 102 and, based thereon, generates data describing the mobile computing device 102. Exemplary sensors 110 comprise one or more of the following: a proximity sensor, a light sensor, and an accelerometer.

The mobile computing device 102 further has one or more computer-readable media such as a memory area 114. The memory area 114 includes any quantity of media associated with or accessible to the mobile computing device 102. The memory area 114 may be internal to the mobile computing device 102 (as shown in FIG. 1), external to the mobile computing device 102 (not shown), or both (not shown).

The memory area 114 stores, among other data, pattern data defining one or more events on the mobile computing device 102. The pattern data may represent, for example, a pre-defined sequence of data, or pre-defined data values, received from the user 108 and/or one or more of the sensors 110 or other components of the mobile computing device 102. The pattern data may also represent thresholds or criteria for use in triggering one or more pre-defined events 122 or actions. For example, the pattern data represents one or more of the following: a pre-defined movement of the mobile computing device 102 and a pre-defined interaction by the user 108 with the mobile computing device 102.

Exemplary pre-defined events 122 include a movement corresponding to the mobile computing device 102 being pulled out of a pocket, a movement corresponding to the mobile computing device 102 being turned so that the screen is facing up, a pre-defined gesture input on the screen, a screen unlock command from the user 108, or the like. Other pre-defined events 122 not specifically mentioned herein yet within the scope of the disclosure are contemplated.

The memory area 114 further stores applications 118 that, when executed by the processor 112, operate to perform functionality on the mobile computing device 102. Exemplary applications 118 include mail application programs, web browsers, calendar application programs, and address book application programs.

In some embodiments, the applications 118 execute to transmit and/or receive application data 120 from a computing device other than the mobile computing device 102. For example, the applications 118 receive application data 120 from the server computing device 104 or any other computing device programmed to provide the applications 118 with the application data 120. The server computing device 104 represents one or more computing devices, and in some embodiments includes a web service.

The mobile computing device 102 communicates with the server computing device 104 via a network 106 such as the Internet. The network 106 includes, however, any wired and/or wireless network over which one or more protocols may be implemented.

In operation, the mobile computing device 102 collects data generated by at least one of the sensors 110. Alternatively or in addition, the mobile computing device 102 collects data input by the user 108 or generated based on user actions. In further embodiments, the mobile computing device 102 collects data indicative of a pre-defined state or characteristic of the mobile computing device 102.

The mobile computing device 102 compares the collected data to the pattern data 116 stored in the memory area 114 to identify an occurrence of at least one of the pre-defined events 122. Based on the identified occurrence of at least one of the pre-defined events 122, the mobile computing device 102 obtains the application data 120 from the server computing device 104. The mobile computing device 102 provides the obtained application data 120 to the user 108. For example, the mobile computing device 102 displays or renders the application data 120 to the user 108 on the user interface 113. The user 108 is then able to interact with the displayed application data 120.

In some embodiments such as described below, the mobile computing device 102 obtains additional application data from the server computing device 104 based on the user interaction with the displayed application data 120. The mobile computing device 102 updates the displayed application data 120 with the obtained additional application data. For example, the displayed application data represents metadata or other high-level descriptive data (e.g., the FROM and SUBJECT lines of electronic mail messages) while the additional application data provides more detailed information (e.g., the BODY of the electronic mail messages).

The radio in the mobile computing device 102 may stay energized for a pre-defined or configurable period of time to continue receiving updates while the user 108 is interacting with the mobile computing device 102. Additionally, radio may stay energized to avoid another radio wakeup should the user 108 disengage the mobile computing device 102 and re-engage the mobile computing device 102 in quick succession. The mobile computing device 102 de-energizes the radio when the connection expires, or after receipt of the application data 120.

Additional operation details and architecture are described with reference to the figures next described.

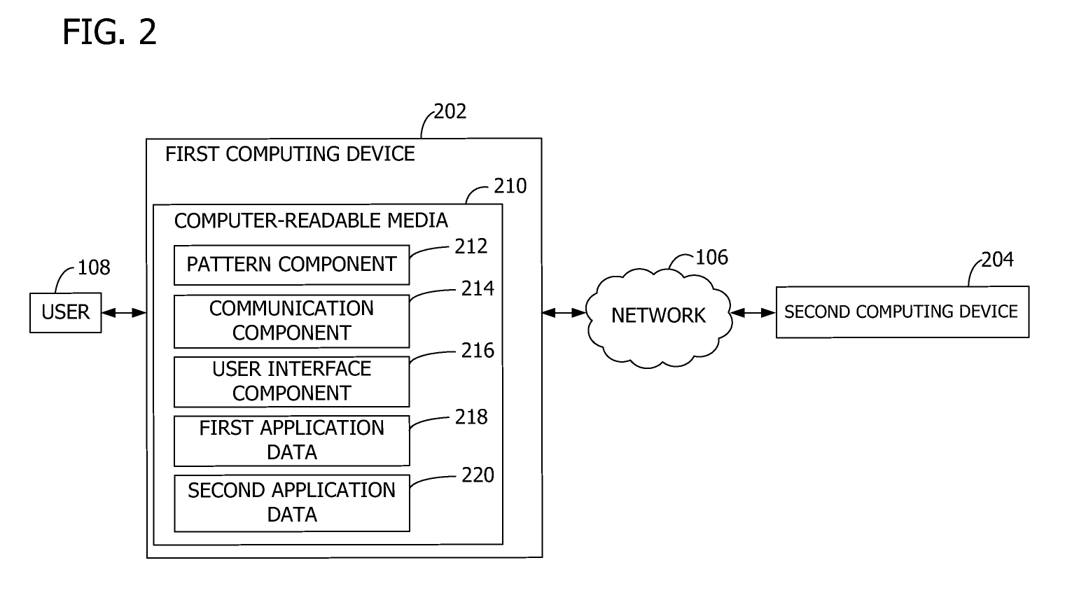

Referring next to FIG. 2, an exemplary block diagram illustrates a first computing device 202 obtaining application data from a second computing device 204. The first computing device 202 (e.g., the mobile computing device 102) communicates with the second computing device 204 (e.g., the server computing device 104) via the network 106. The first computing device 202 includes, among other features, one or more computer-readable media 210 storing first application data 218, second application data 220, and computer-executable components.

Exemplary components include a pattern component 212, a communication component 214, and a user interface component 216. The pattern component 212, when executed by the processor 112 of the first computing device 202, causes the processor 112 to monitor interaction by the user 108 with the first computing device 202 to detect occurrence of a first pre-defined event on the first computing device 202. The communication component 214, when executed by the processor 112 of the first computing device 202, causes the processor 112 to obtain the first application data 218 from the second computing device 204 responsive to the detected occurrence of the first pre-defined event by the pattern component 212. The first application data 218 relates to applications (e.g., applications 118) executing on the first computing device 202. The user interface component 216, when executed by the processor 112 of the first computing device 202, causes the processor 112 to display on the first computing device 202 the first application data 218 obtained by the communication component 214.

The pattern component 212 then monitors interaction by the user 108 with the first application data 218 displayed by the user interface component 216 to detect occurrence of a second pre-defined event on the first computing device 202. Responsive to the detected occurrence of the second pre-defined event by the pattern component 212, the communication component 214 obtains second application data 220 from the second computing device 204. The second application data 220 represents more detailed information based, in some embodiments, on the first application data 218. For example, the first application data 218 includes metadata describing the second application data 220. In another example, the first application data 218 includes a plurality of items, and the second application data 220 includes data describing each of the plurality of items. The user interface component 216 provides the obtained second application data 220 for display on the first computing device 202.

In some embodiments, if an occurrence of the first pre-defined event is not detected by the pattern component 212 within a pre-defined idle time (e.g., three hours), the communication component 214 obtains the first application data 218. In this manner, the first computing device 202 limits the amount of the first application data 218 obtained upon the eventual occurrence of the first pre-defined event. For example, the quantity of new messages downloaded during any given update is less if new messages are regularly downloaded (e.g., every three hours) while the first computing device 202 is idle.

In some embodiments, the pattern component 212, the communication component 214, and the user interface component 216 execute as part of an operating system associated with the computing device.

Referring next to FIG. 3, an exemplary flow chart illustrates operation of a computing device (e.g., the first computing device 202) to obtain the first application data 218 and the second application data 220 in response to detecting occurrence of a pre-defined event. The first computing device 202 determines whether the pre-defined event (or one of the pre-defined events 122) has occurred on the first computing device 202 at 302. For example, the first computing device 202 receives, obtains, generates, or otherwise accesses data associated with the first computing device 202. For example, the data may be obtained by monitoring current interaction by the user 108 with the first computing device 202. This data is compared to pre-defined criteria, thresholds, pattern data 116, or other filter to detect the occurrence of the pre-defined event.

In some embodiments, detecting the occurrence of the pre-defined event includes detecting one or more of the following: a pre-defined movement of the first computing device 202, activation of a backlight on the first computing device 202, activation of an alarm on the first computing device 202, receipt of pre-defined data on the first computing device 202, holding of the first computing device 202 by the user 108 and receipt of an incoming call to the first computing device 202.

The first computing device 202 may also predict occurrence of the pre-defined event by analyzing historical interaction by the user 108 with the first computing device 202. In some embodiments, the first computing device 202 identifies a recurring synchronization pattern based on the historical interaction. The recurring synchronization pattern may be based on, for example, time, a particular sequence of user actions, or other criteria. For example, the first computing device 202 determines that the user 108 checks for new electronic mail messages at 2 p.m. every day, or checks for new electronic mail messages immediately after executing another particular application. The pre-defined event then becomes the next repetition of the pattern, and the first computing device 202 obtains the first application data 218 upon occurrence of the next repetition of the pattern.

In another example, the first computing device 202 detects the occurrence of the pre-defined event based on a calendar appointment. For example, the event is defined to be the calendar entry, and the occurrence of the event is detected at the time associated with the calendar appointment.

Upon detecting the occurrence of the pre-defined event at 302, the first computing device 202 obtains the first application data 218 from the second computing device 204 at 304. The obtained first application data 218 is provided for user consumption on the first computing device 202 at 306. The user 108 is able to interact with the displayed first application data 218 at 308.

While the user 108 is interacting with the displayed first application data 218 at 308, the first computing device 202 obtains the second application data 220 from the second computing device 204 at 310. At 312, the first computing device 202 provides the second application data 220 to the user 108 for consumption (e.g., display, playing audio, etc.).

In some embodiments, the first computing device 202 selects or adjusts the type or quantity, or characteristics or qualities of the second application data 220 to be obtained based on the current user interaction with the displayed first application data 218.

In an example, the pre-defined event is the user 108 turning on the backlight of the first computing device 202. As the backlight turns on, the first computing device 202 obtains the FROM and SUBJECT fields of new electronic mail messages as well as the titles of new appointment requests as the first application data 218. If the user 108 selects a mail application icon, the first computing device 202 detects this interaction and obtains the BODY of the new electronic mail messages as the second application data 220. Alternatively, if the user 108 selects a calendar application icon, the first computing device 202 detects this interaction and obtains the content of the new appointment requests.

In another example, the first computing device 202 obtains data indicating whether new electronic mail messages are available as well as a quantity of the new electronic mail messages as the first application data 218. The quantity of new electronic mail messages is displayed to the user 108 on a lock screen of the first computing device 202. If the user 108 unlocks (or attempts to unlock) the lock screen, the first computing device 202 detects this interaction and obtains the FROM and SUBJECT fields of the new electronic mail messages as the second application data 220. While the user 108 reviews the second application data 220, the first computing device 202 obtains additional second application data 220 such as the BODY of the new electronic mail messages in anticipation of the user 108 selecting one of the displayed new electronic mail messages for reading.

Other examples are within the scope of the disclosure, such as in a calendar application or social networking application. In the calendar application, the DATE and SUBJECT fields of new calendar entries are obtained as the first application data 218. The DATE and SUBJECT fields are displayed to the user 108 on the lock screen, in a popup shown after device unlock, or near the calendar application icon. The BODY field of the new calendar entries is obtained as the second application data 220 while the user 108 is reviewing the first application data 218. In the social networking application, truncated messages or a quantity of new messages may be displayed as the first application data 218. The full messages are then obtained as the second application data 220.

In some embodiments, the second application data 220 represents a portion of the second application data 220 available on the second computing device 204. In such embodiments, the first computing device 202 anticipates what data the user 108 wants, and iteratively or repeatedly or incrementally obtains (e.g., in the background) additional second application data for consumption by the user 108.

Referring next to FIG. 4, an exemplary flow chart illustrates just-in-time synchronization of application data between the first computing device 202 and the second computing device 204. At 402, the first computing device 202 determines an anticipated interaction (e.g., occurrence of a pre-defined event) based on one or more of the following: data from the sensors 110, a backlight of a screen of the first computing device 202 turning on, activation of an alarm, receipt of a notification or reminder for a calendar entry, receipt of an incoming call, and a routine established by the user 108 (e.g., the user 108 often checks for new electronic mail messages at 9:15 am).

If an anticipated interaction has not been detected at 404, the first computing device 202 determines whether the first computing device 202 has been idle for a pre-defined period of time (e.g., three hours) at 406. If the first computing device 202 has been idle for the pre-defined period of time, the first computing device 202 performs some form of synchronization with the second computing device 204 (e.g., partial or full) at 408. The process continues at 402 again to determine an anticipated interaction. If the first computing device 202 has not been idle for the pre-defined period of time, the process continues at 402 again to determine an anticipated interaction.

If an anticipated interaction has been detected at 404, the first computing device 202 fetches minimal data at 410. For example, the first computing device 202 obtains data indicating whether there are any new electronic mail messages in any of the mail accounts accessible by the first computing device 202. If so, in some embodiments, the fetched data is displayed to the user 108 on a lock screen of the first computing device 202. Aspects of the disclosure adjust the amount and type of the minimal data to fetch such that the data is fetched quickly to avoid latency apparent to the user 108. The minimal data represents data the user 108 wants to consume at a first glance and provides time for aspects of the disclosure to fetch additional data while the user 108 engages with the minimal data (e.g., review the minimal data, launch applications, etc.).

After displaying the fetched data to the user 108, the first computing device 202 fetches additional data at 412. In some embodiments, the additional data corresponds to the previously-fetched data. For example, while the user 108 unlocks the first computing device 202, headers (e.g., FROM and SUBJECT fields) for the new electronic mail messages are fetched. The additional data is displayed to the user 108 after the user 108 completes unlocking the lock screen of the first computing device 202.

Subsequently, the user 108 completes reviewing the fetched additional data and locks the screen, or otherwise turns off the backlight at 414. For example, the backlight may turn off automatically as part of a screen saver or idle sequence. In some embodiments, the last request for data from the first computing device 202 is not cancelled, but any subsequently received data is processed. For example, the lock screen may be updated with this received data. The process then repeats at 402.

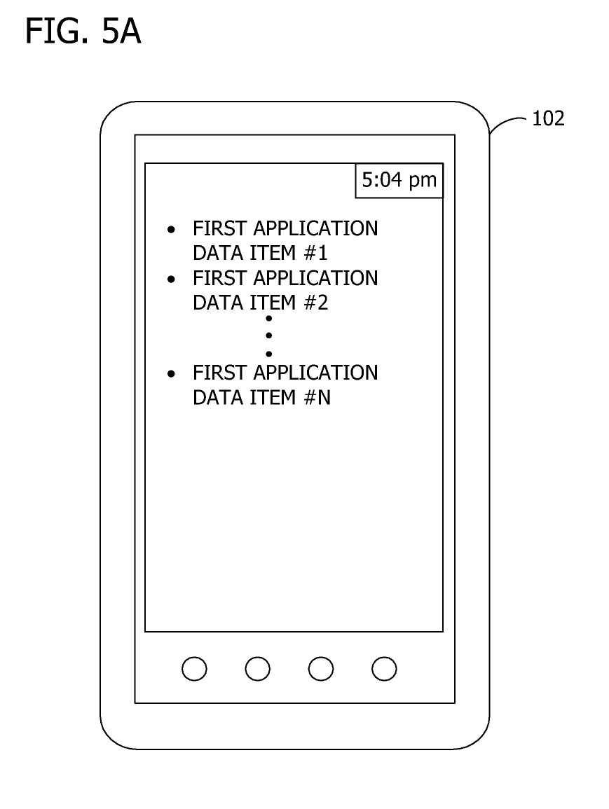

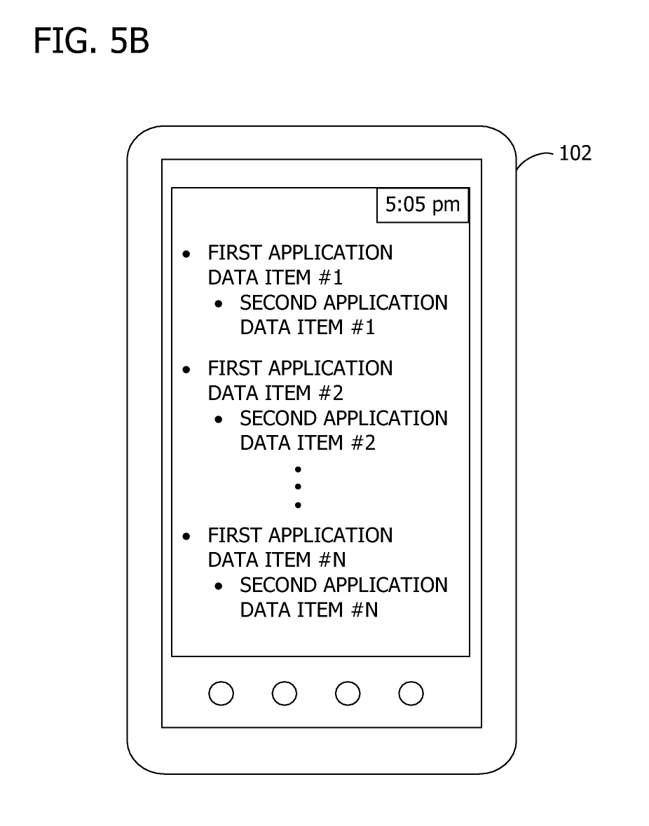

Referring next to FIG. 5A, an exemplary mobile computing device 102 illustrates data items displayed in a user interface. The user interface of FIG. 5A displays the first application data 218 to the user 108 in the form of first application data item #1 through first application data item #N. In some embodiments, the first application data items are displayed to the user 108 on the lock screen.

Referring next to FIG. 5B, the exemplary mobile computing device 102 from FIG. 5B illustrates additional detail for the data items displayed in the user interface. The user interface displays the second application data 220 to the user 108 in the form of second application data item #1 through second application data item #N. Each of the second application data items is displayed in the example of FIG. 5B proximate to the corresponding first application data items.

In some embodiments, the second application data items are displayed to the user 108 after the user 108 has unlocked the screen or performed another action that indicates that the second application data items are desired by the user 108.

### Additional Examples

In some embodiments, once the radio in the mobile computing device 102 has energized to obtain the application data for a particular application, the disclosure opportunistically obtains application data for other applications to take advantage of the availability of the radio.

At least a portion of the functionality of the various elements in FIG. 1 and FIG. 2 may be performed by other elements in FIG. 1 or FIG. 2, or an entity (e.g., processor, web service, server, application program, computing device, etc.) not shown in FIG. 1 or FIG. 2.

In some embodiments, each of the operations illustrated in FIG. 3 and FIG. 4 are performed by the same computing device. In other embodiments, one or more of the operations illustrated in FIG. 3 or FIG. 4 are performed by another computing device (e.g., as a web service). Further, the operations illustrated in FIG. 2 and FIG. 4 may be implemented as software instructions encoded on a computer-readable medium, in hardware programmed or designed to perform the operations, or both.

While embodiments have been described with reference to data collected from users, aspects of the disclosure provide notice to the users of the collection of the data (e.g., via a dialog box or preference setting) and the opportunity to give or deny consent. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for determining imminent use by the user 108 of the mobile computing device 102, and exemplary means for updating the application data on the mobile computing device 102 in response to a determination of imminent use by the user 108 of the mobile computing device 102.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for determining imminent use of a mobile computing device and updating application data on the mobile computing device in response thereto, said system comprising:
one or more sensors associated with a mobile computing device; said sensors generating data describing the mobile computing device;
a memory area associated with a mobile computing device, said memory area storing pattern data defining one or more events on the mobile computing device;
a processor programmed to:
collect the data generated by one or more of the sensors;
compare the collected data to the pattern data stored in the memory area to identify an occurrence of at least one of the events;
based on the identified occurrence of said at least one of the events, obtain application data from a server computing device, said application data relating to applications executing on the mobile computing device; and
provide the obtained application data for display on the mobile computing device.

2. The system of claim 1, wherein the processor is further programmed to:
enable interaction by a user of the mobile computing device with the displayed application data;
obtain additional application data from the server computing device, wherein the application data includes metadata describing the additional application data; and
providing the obtained additional application data for display on the mobile computing device.

3. The system of claim 1, wherein the processor is further programmed to obtain the application data from the server computing device after a pre-defined idle time.

4. The system of claim 1, wherein the sensors comprise one or more of the following: a proximity sensor, a light sensor, and an accelerometer.

5. The system of claim 1, wherein the memory area stores the pattern data representing one or more of the following: a pre-defined movement of the mobile computing device and a pre-defined interaction by the user with the mobile computing device.

6. The system of claim 1, further comprising means for determining imminent use by the user of the mobile computing device.

7. The system of claim 1, further comprising means for updating the application data on the mobile computing device in response to a determination of imminent use by the user of the mobile computing device.

8. A method comprising:
detecting, by a first computing device, occurrence of a pre-defined event on the first computing device;
responsive to said detecting, obtaining first application data by the first computing device from a second computing device, said first application data relating to applications executing on the first computing device;
providing the obtained first application data for display on the first computing device;
enabling interaction by a user with the displayed first application data;
obtaining second application data by the first computing device from the second computing device, wherein the first application data includes metadata describing the second application data; and
providing the obtained second application data for display on the first computing device.

9. The method of claim 8, wherein obtaining the second application data comprises obtaining the second application data based on interaction by the user with the displayed first application data.

10. The method of claim 8, wherein the first application data represents a portion of application data available for the applications.

11. The method of claim 8, wherein the first application data includes a plurality of items, and wherein the second application data includes data describing each of the plurality of items.

12. The method of claim 8, wherein detecting the occurrence of the pre-defined event comprises:
receiving data associated with the first computing device; and
comparing the received data to pre-defined criteria to detect occurrence of the pre-defined event.

13. The method of claim 12, wherein receiving the data comprises receiving one or more of the following: data from one or more sensors associated with the first computing device, data from the user of the first computing device, data indicating a pre-defined state of the first computing device, and data representing a pre-defined characteristic of the first computing device.

14. The method of claim 8, further comprising defining the pre-defined event based on a history of interaction between the user and the first computing device.

15. The method of claim 8, wherein detecting the occurrence of the pre-defined event comprises detecting one or more of the following: movement of the first computing device, activation of a backlight on the first computing device, activation of an alarm on the first computing device, receipt of pre-defined data on the first computing device, holding of the first computing device by the user, and receipt of an incoming call to the first computing device.

16. The method of claim 8, further comprising:
monitoring interaction by the user with the first computing device;
identifying a recurring synchronization pattern based on the monitored interaction; and
obtaining first application data in accordance with the identified, recurring synchronization pattern.

17. The method of claim 8, wherein detecting the occurrence of the pre-defined event comprises anticipating a scheduled occurrence of a calendar appointment.

18. One or more computer-readable media having computer-executable components, said components comprising:
a pattern component that when executed by at least one processor of a first computing device causes the at least one processor to monitor interaction by a user with the first computing device to detect occurrence of a first pre-defined event on the first computing device;
a communication component that when executed by at least one processor of the first computing device causes the at least one processor to obtain, responsive to the detected occurrence of the first pre-defined event by the pattern component, first application data from a second computing device, said first application data relating to applications executing on the first computing device; and
a user interface component that when executed by at least one processor of the first computing device causes the at least one processor to display on the first computing device the first application data obtained by the communication component,
wherein the pattern component monitors user interaction by the user with the first application data displayed by the user interface component to detect occurrence of a second pre-defined event on the first computing device,
wherein the communication component obtains, responsive to the detected occurrence of the second pre-defined event by the pattern component, second application data from the second computing device, and
wherein the first application data includes metadata describing the second application data

19. The computer-readable media of claim 18, further comprising: wherein the user interface component provides the obtained second application data for display on the first computing device.

20. The computer-readable media of claim 18, wherein the communication component obtains the first application data after a pre-defined idle time.
